(19) United States
(12) Patent Application Publication
(10) Pub. No.: US 2009/0217378 A1
(43) Pub. Date: Aug. 27, 2009

(54) Boot Time Remediation of Malware

(75) Inventors: Joseph Jared Johnson, Seattle, WA (US); Catalin Daniel Sandu, Redmond, WA (US); Michael Sean Jarrett, Kirkland, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/038,792

(22) Filed: Feb. 27, 2008

(51) Int. Cl. G06F 21/00

(52) U.S. Cl. 726/23

(57) ABSTRACT

Aspects of the subject matter described herein relate to removing malware from a computer system. In aspects, an anti-malware engine detects malware and writes a tool onto a storage device. The anti-malware engine disguises the tool to make it more difficult for malware to detect that the tool is on the storage device. In addition, the anti-malware engine encrypts and writes remediation actions to be taken by the tool to the storage device and requests that the computer reboot. After rebooting, the computer executes the tool which takes the remediation actions including removing the malware.

### BACKGROUND

In one sense, malware includes unwanted software that is installed on a computer. Malware may be hostile, intrusive, or annoying. It may be designed to infiltrate or damage a computer system without the owner's informed consent. Malware can be relatively benign or severely disruptive. Some malware can spread from computer to computer via networks or the use of removable computer-readable media. Some malware attempts to remain hidden from user inspection while other malware becomes obvious immediately.

The number of malware continues to grow at a phenomenal rate. Vendors that produce malware detection and removal products are continually updating the list of malware their products can detect and remove. Guarding against malware is an ongoing challenge.

### SUMMARY

Briefly, aspects of the subject matter described herein relate to removing malware from a computer system. In aspects, an anti-malware engine detects malware and writes a tool onto a storage device. The anti-malware engine disguises the tool to make it more difficult for malware to detect that the tool is on the storage device. In addition, the anti-malware engine encrypts and writes remediation actions to be taken by the tool to the storage device and requests that the computer reboot. After rebooting, the computer executes the tool which takes the remediation actions including removing the malware.

This Summary is provided to briefly identify some aspects of the subject matter that is further described below in the Detailed Description. This Summary is not intended to identify key or essential features of the claimed subject matter, nor is it intended to be used to limit the scope of the claimed subject matter.

The phrase “subject matter described herein” refers to subject matter described in the Detailed Description unless the context clearly indicates otherwise. The term “aspects” is to be read as “at least one aspect.” Identifying aspects of the subject matter described in the Detailed Description is not intended to identify key or essential features of the claimed subject matter.

The aspects described above and other aspects of the subject matter described herein are illustrated by way of example and not limited in the accompanying figures in which like reference numerals indicate similar elements and in which:

### BRIEF DESCRIPTION OF THE DRAWINGS

FIG. 1 is a block diagram representing an exemplary general-purpose computing environment into which aspects of the subject matter described herein may be incorporated;

FIG. 2 is a block diagram representing an exemplary environment in which malware is detected and actions are taken prior to restarting a system to remediate the malware in accordance with aspects of the subject matter described herein;

FIG. 3 is a block diagram representing an exemplary environment in which the tool 225 of FIG. 2 executes after restarting the system 200 of FIG. 2 in accordance with aspects of the subject matter described herein; and

FIGS. 4-5 are flow diagrams that general represent actions that may occur in detecting malware and taking remediation actions in response thereto in accordance with aspects of the subject matter described herein.

### DETAILED DESCRIPTION

### Exemplary Operating Environment

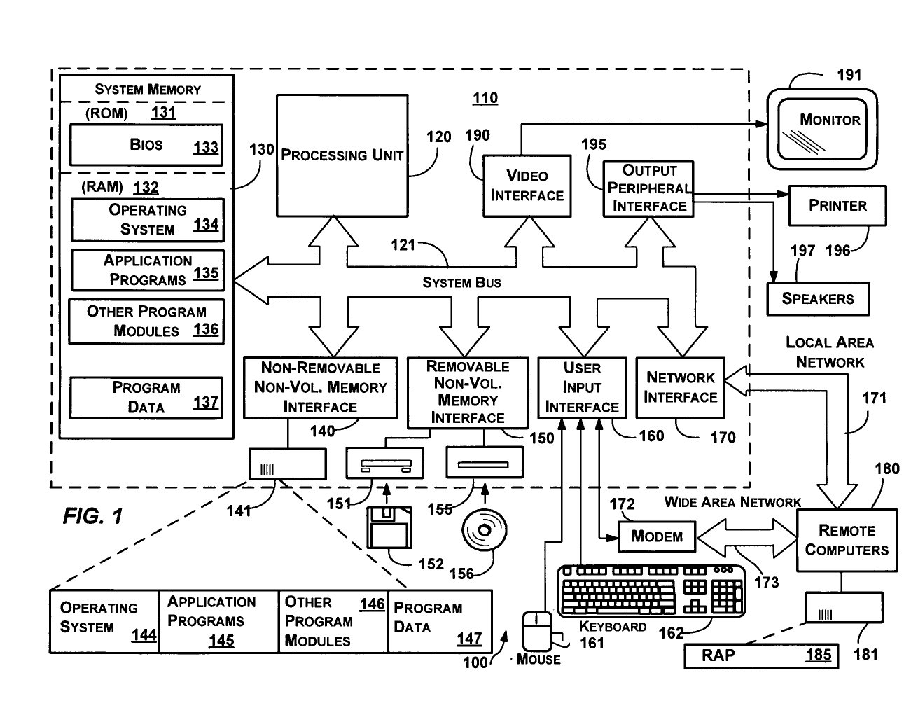

FIG. 1 illustrates an example of a suitable computing system environment 100 on which aspects of the subject matter described herein may be implemented. The computing system environment 100 is only one example of a suitable computing environment and is not intended to suggest any limitation as to the scope of use or functionality of aspects of the subject matter described herein. Neither should the computing environment 100 be interpreted as having any dependency or requirement relating to any one or combination of components illustrated in the exemplary operating environment 100.

Aspects of the subject matter described herein are operational with numerous other general purpose or special purpose computing system environments or configurations. Examples of well known computing systems, environments, and/or configurations that may be suitable for use with aspects of the subject matter described herein include, but are not limited to, personal computers, server computers, hand-held or laptop devices, multiprocessor systems, microcontroller-based systems, set top boxes, programmable consumer electronics, network PCs, minicomputers, mainframe computers, distributed computing environments that include any of the above systems or devices, and the like.

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing aspects of the subject matter described herein includes a general-purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile discs (DVDs) or other optical disk storage, magnetic cassettes, magnetic tape, magnetic disk storage or other magnetic storage devices, or any other medium which can be used to store the desired information and which can be accessed by the computer 110. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disc drive 155 that reads from or writes to a removable, nonvolatile optical disc 156 such as a CD ROM or other optical media. Other removable/non-removable, volatile/nonvolatile computer storage media that can be used in the exemplary operating environment include, but are not limited to, magnetic tape cassettes, flash memory cards, digital versatile discs, digital video tape, solid state RAM, solid state ROM, and the like. The hard disk drive 141 is typically connected to the system bus 121 through a non-removable memory interface such as interface 140, and magnetic disk drive 151 and optical disc drive 155 are typically connected to the system bus 121 by a removable memory interface, such as interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, a touch-sensitive screen of a handheld PC or other writing tablet, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

### Malware Remediation

As mentioned previously, malware is a significant problem to computer systems. In one embodiment, malware may include computer viruses, worms, Trojan horses, spyware, unwanted adware, other malicious or unwanted software, and the like. In another embodiment, malware may include software that presents material that is considered to be obscene, lewd, lascivious, filthy, excessively violent, harassing, or otherwise objectionable.

Malware is becoming increasingly difficult to remove. Malware will often inject itself into threads or other code of other running processes including critical system processes. If anti-malware software attempts to remove the malware from a critical system process, this often causes the system to stop functioning.

To deal with this “stubborn” malware, anti-malware software may attempt to remove the malware during reboot by writing the name of the malware file to remove in a well known location in a registry or other database or some other well known location and requesting a reboot of the system. Malware may monitor for this removal activity and may delete the name of the malware file prior to the system rebooting. Thus, on reboot, the malware remains installed in the system.

To address this issue and others, aspects of the subject matter described herein relate to creating a mechanism by which malware may be removed. In aspects of the subject matter described herein, after detecting malware, an anti-malware engine may take disguised actions to remove the malware from the system. These disguised actions may include writing a tool onto a hard disk using a random file name, encrypting the actions to be taken by the tool, requesting a reboot of the system, and executing the tool during reboot before the malware is able to execute.

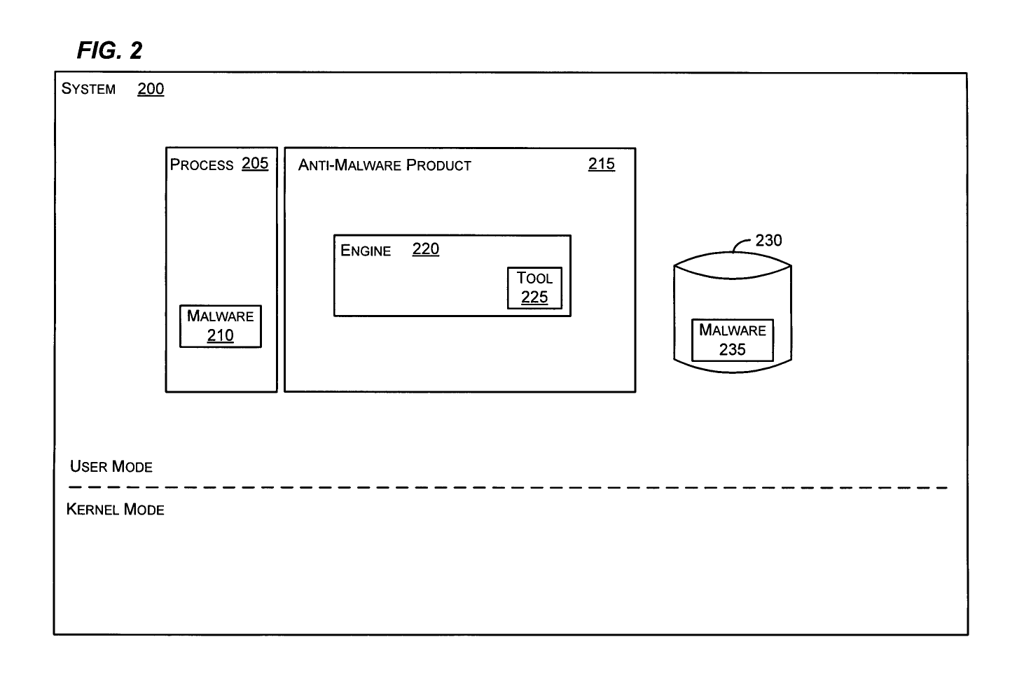

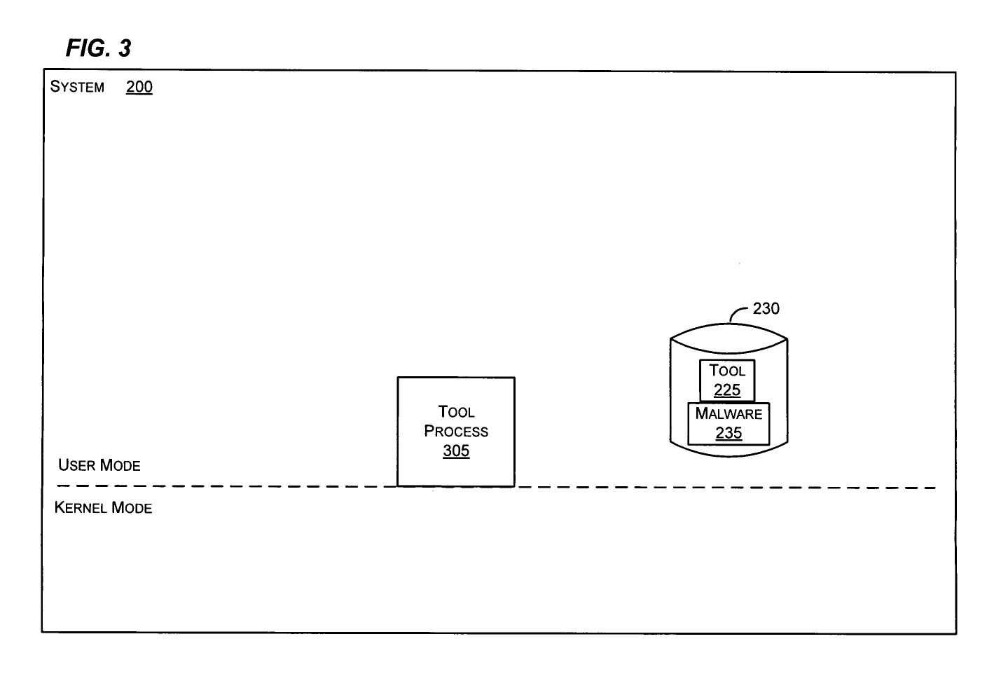

FIGS. 2-3 are block diagrams illustrating various components that may be included in an environment arranged in accordance with aspects of the subject matter described herein. The components illustrated in FIGS. 2-3 are exemplary and are not meant to be all-inclusive of components that may be needed or included. In other embodiments, the components or functions described in conjunction with FIGS. 2-3 may be included in other components or placed in subcomponents without departing from the spirit or scope of aspects of the subject matter described herein.

FIG. 2 is a block diagram representing an exemplary environment in which malware is detected and actions are taken prior to restarting a system to remediate the malware in accordance with aspects of the subject matter described herein. The environment includes a system 200 that includes a process 205, an anti-malware product 215, and a store 230. The process 205 includes malware 210. The anti-malware product 215 includes an engine 220 that includes a tool 225. The store 230 includes malware 235 which corresponds to the malware 210 that is within the process 205.

The system 200 comprises an environment in which processes may execute. In one embodiment, the system 200 comprises a computer such as the computer 110 of FIG. 1. In another embodiment, the system 200 comprises a virtual machine that has virtual hardware.

The process 205 may be a system process or other process that if killed will cause the system to crash or otherwise function incorrectly. Thus, the anti-malware product 215 may not be able to kill the process 205 to remove the malware 210 without causing adverse effects. The malware 210 may monitor for activities intended to remove the malware 210 and may attempt to protect itself against such activities.

The anti-malware product 215 includes an engine 220 that is designed to detect malware such as the malware 210. The engine 220 includes a tool 225 that is designed to remove malware when the system 200 is restarted. The engine 220 may be replaced periodically as an anti-malware vendor creates new versions of the engine 220 to deal with new malware and provides the versions to customers. Likewise, the tool 225, may be updated and changed so that if malware is designed to combat the malware removing features of the tool 225, that the tool can be changed so that the malware can no longer detect the new version of the tool 225 without the malware being redesigned.

In one embodiment, the tool 225 resides in the anti-malware product 215 and is not placed on the store 230 until after the engine 220 detects the malware 210 and begins to take remediation actions to remove the malware. After the tool 225 takes the remediation actions, it is removed from the store 230. This is done, in part, in an attempt make it more difficult for malware writers to analyze and combat the tool 225.

When the tool 225 is placed on the data store, it may be given a random name and placed in a random location in the data store. Again, this is done, in part, to make it more difficult for the malware 210 to detect that the tool 225 has been placed on the store 230 as the malware 210 may be looking for a specifically named tool in a specific directory.

In addition to the tool, the engine 220 may write a list of one or more remediation actions onto the store 230. These remediation actions are to be performed by the tool 225 when the tool 225 is executed after the system 200 is restarted. The remediation actions may include, for example, removing the malware, modifying configuration files (e.g., a system registry), and the like upon restarting the system 200. The tool 225 may be structured to avoid removing files indicated by a symbolic link (e.g., a tactic malware sometimes uses to avoid its removal).

The remediation actions may be encrypted to disguise what actions are going to be taken to what files upon restarting the system 200. The remediation actions may also be stored in a random file name and placed in a random directory to defend against malware actions to abort the remediation actions. Malware that is scanning for changes that affect it may not know that the remediation actions have been written to the store 230 and/or may not be able to decrypt the remediation actions to determine that the malware is in danger of being removed from the system 200.

In conjunction with writing the tool 225 to the store 230, the anti-malware product 215 may configure the system 200 to execute the tool 225 on the store 230 upon restarting. The anti-malware product 215 may also request that the system 200 restart in order that the tool 225 may execute and remove the malware 235 from the store 230.

FIG. 3 is a block diagram representing an exemplary environment in which the tool 225 of FIG. 2 executes after restarting the system 200 of FIG. 2 in accordance with aspects of the subject matter described herein. The tool image 225 stored on the store 230 is executed to create the tool process 305.

The tool process 305 may be executed very early in the booting process such that it executes at a time after drivers and other kernel mode processes have been initialized but before regular user mode processes begin to execute. This may be accomplished by structuring the tool 225 such that it does not need all of the system user mode processes to be running in order for the tool process 305 to execute and then having the system execute the tool process 305 before the system 200 executes other user mode processes.

When the tool process 305 executes, it removes the malware 235 from the store 230 before the malware 235 is able to execute. As the malware 235 is unable to execute, it cannot inject itself into system processes and defend itself from removal.

The tool process 305 may also change configuration files and take other remediation actions as described previously. After the tool process 305 executes, the tool image 225 may be removed from the store 230

Although the entities illustrated in FIG. 2-3 are illustrated as being in user mode or in kernel mode, in other embodiments, one or more of the entities that are shown as being in user mode may be in kernel mode and vice versa.

Furthermore, in some embodiments, one or more of the entities that are illustrated as being in user or kernel mode may be distributed in both user and kernel mode such that a portion of the entity (and/or its functions) executes in kernel mode and a portion of the entity (and/or its functions) executes in user mode.

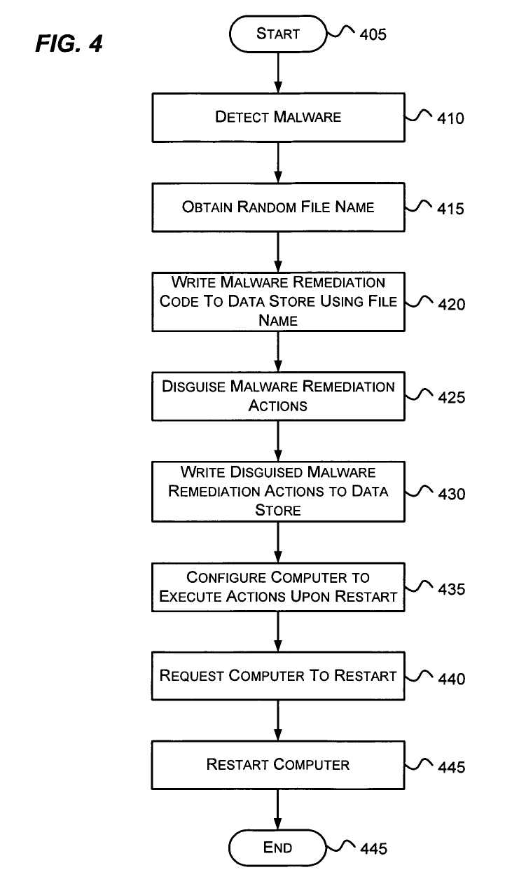

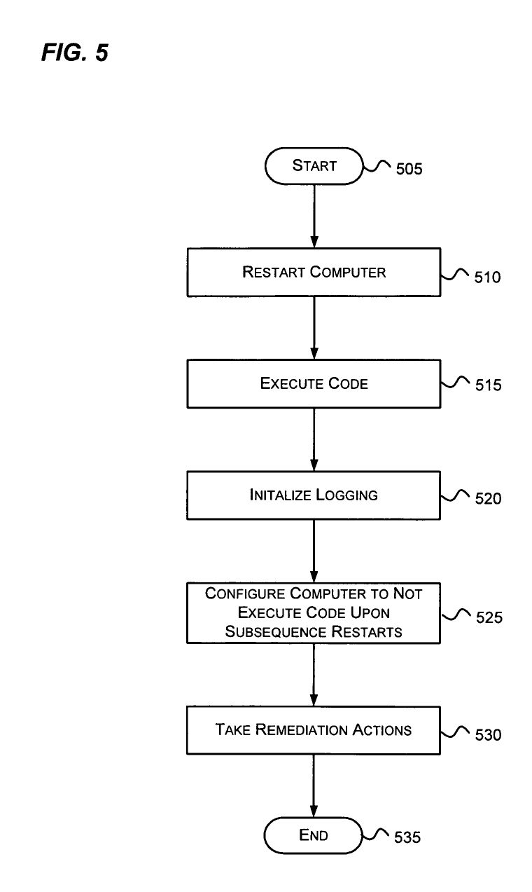

FIGS. 4-5 are flow diagrams that general represent actions that may occur in detecting malware and taking remediation actions in response thereto in accordance with aspects of the subject matter described herein. For simplicity of explanation, the methodology described in conjunction with FIGS. 4-5 are depicted and described as a series of acts. It is to be understood and appreciated that aspects of the subject matter described herein are not limited by the acts illustrated and/or by the order of acts. In one embodiment, the acts occur in an order as described below. In other embodiments, however, the acts may occur in parallel, in another order, and/or with other acts not presented and described herein. Furthermore, not all illustrated acts may be required to implement the methodology in accordance with aspects of the subject matter described herein. In addition, those skilled in the art will understand and appreciate that the methodology could alternatively be represented as a series of interrelated states via a state diagram or as events.

Turning to FIG. 4, at block 405, the actions begin. At block 410, the anti-malware detects malware. For example, referring to FIG. 2, the engine 220 detects the malware 210 included in the process 205.

At block 415, a random file name is obtained. For example, referring to FIG. 2, the engine 220 obtains a random file name. To obtain the random file name, the engine 220 may generate the name or obtain it from another process.

At block 420, malware remediation code is written to a data store using the random file name. For example, referring to FIG. 2, the engine 220 writes code corresponding to the tool 225 to the store 230.

At block 425, remediation actions the remediation code is to execute are disguised. For example, referring to FIG. 2, the engine 220 encrypts actions that are to be taken by the tool 225 upon reboot. Exemplary actions have been described previously and will not be described in more detail here.

At block 430, the disguised remediation actions are written to the data store. For example, referring to FIG. 2, the engine 220 writes the encrypted actions to the store 230. In some embodiments, the actions may be encapsulated with the tool 225. In these embodiments, writing the tool 225 to the store 230 also causes the actions to be written to the store 230.

At block 435, the computer is configured to execute the remediation code upon restart. For example, referring to FIG. 2, the system 200 may be configured to execute the tool image 225 as written on the store 230 upon reboot of the system.

At block 440, a request to restart the computer is performed. For example, referring to FIG. 2, the anti-malware product 215 requests that the system 200 reboot. It may be some time afterward the request that the system 200 actually reboots. In addition, rebooting the system may involve user interaction (e.g., a window asking the user if it is alright to reboot the system 200).

At block 445, the computer is restarted. For example, referring to FIG. 2, the system 200 is rebooted.

At block 450, the actions end.

Turning to FIG. 5, at block 505, the actions begin. At block 510, a computer is restarted. For example, referring to FIG. 2, the system 200 is rebooted. The actions corresponding to block 510 may occur at block 445 of FIG. 4.

At block 515, the remediation tool begins executing. For example, referring to FIG. 3, the tool image 225 on the store 230 begins executing. The tool process 305 is a process that results from this execution.

At block 520, logging is initialized. For example, referring to FIG. 3, the tool process 305 initializes a log to indicate the status of its activities with respect to taking remediation actions. In addition, the log may be used to provide feedback and instructions for the next instance of the engine. For example, the log might tell the engine to take some additional remediation actions that are necessary for a complete remediation.

At block 525, the computer is configured to not execute the remediation tool upon subsequent restarts. For example, referring to FIG. 3, the tool 225 is removed from the bootup sequence of the system 200.

At block 530, one or more remediation actions are taken. For example, referring to FIG. 3, the tool process 305 executes remediation actions previously placed on the store 230 by the anti-malware product 215 of FIG. 2 prior to rebooting the system 200. In performing these actions, the tool process 305 may need to decrypt the actions before executing them.

At block 530, the actions end.

As can be seen from the foregoing detailed description, aspects have been described related to removing malware from a computer system. While aspects of the subject matter described herein are susceptible to various modifications and alternative constructions, certain illustrated embodiments thereof are shown in the drawings and have been described above in detail. It should be understood, however, that there is no intention to limit aspects of the claimed subject matter to the specific forms disclosed, but on the contrary, the intention is to cover all modifications, alternative constructions, and equivalents falling within the spirit and scope of various aspects of the subject matter described herein.

What is claimed is:

1. A method implemented at least in part by a computer, the method comprising:
detecting malware on a computer system;
writing code onto a storage associated with the computer system, the code to be executed upon a restart of the computer system, the code related to removing the malware from the computer system;
configuring the computer system to execute the code upon the restart; and
requesting that the computer system restart.

2. The method of claim 1, further comprising writing one or more remediation actions onto the storage, the remediation actions to be performed by the code upon the restart.

3. The method of claim 2, further comprising encrypting the one or more remediation actions.

4. The method of claim 2, wherein writing one or more remediation actions onto the storage comprises generating a random file name for a file in which to place the one or more remediation actions.

5. The method of claim 1, further comprising obtaining a random file name with which to write the code onto the storage, wherein obtaining a random file name comprises selecting an existing directory at random and generating a random name within that directory.

6. The method of claim 1, further comprising obtaining a random file name with which to write the code onto the storage, wherein obtaining the random file name comprises selecting a predetermined directory and generating a random name within that directory.

7. The method of claim 1, further comprising removing the code from the storage shortly after the code is executing in memory after the restart.

8. The method of claim 1, wherein a process including the malware may not be killed without crashing or otherwise making inoperable the computer system.

9. The method of claim 1, wherein configuring the computer system to execute the code upon the restart comprises configuring the computer system to execute the code prior to the computer system being ready to execute non-system type user mode processes.

10. A computer storage medium having computer-executable instructions, which when executed perform actions, comprising:
restarting a computer system;
executing code that was written to storage associated with the computer system, the code targeted to execute a remediation action with respect to malware installed on the computer system, the malware being resistant to removal when the computer system is executing the malware;
configuring the computer system to not execute the code during subsequent restarts of the computer system; and
initializing a log that relates, in part, to whether the code is able to perform the remediation action.

11. The computer storage medium of claim 10, wherein the remediation action comprises modifying a registry associated with an operating system that executes on the computer system.

12. The computer storage medium of claim 10, further comprising using the log to determine additional remediation actions to take with respect to the malware.

13. The computer storage medium of claim 10, wherein the remediation action comprises removing a file that includes the malware.

14. The computer storage medium of claim 10, wherein the malware being resistant to removal after the computer system has executed the malware comprises the malware injecting a thread into a user mode system process, the system process, if killed, causing the computer system to crash.

15. The computer storage medium of claim 10, wherein the code removes the malware regardless of whether a symbolic link associated with the malware has been changed prior to executing the code.

16. The computer storage medium of claim 10, wherein the computer system comprises a virtual computer system having virtualized hardware.

17. The computer storage medium of claim 10, wherein the code was previously written to the storage using a random file name.

18. In a computing environment, an apparatus, comprising:
a process that includes malware, the process being such that if the process is killed it crashes a system upon which the process executes;
an anti-malware product, the anti-malware product including an engine operable to identify the malware, the engine being further operable to perform further actions, comprising:
writing code onto a storage associated with the apparatus using the random file name, the code to perform a remediation action with respect to the malware after the operating system is restarted and the code is executed,
configuring the operating system to execute the code upon restart, and
requesting that the operating system restart.

19. The apparatus of claim 18, wherein the engine is further operable to encrypt the remediation action in conjunction with writing the remediation action code onto the storage.

20. The apparatus of claim 18, wherein the remediation action comprises removing the malware from the storage.
